(19) United States
(12) Patent Application Publication
(10) Pub. No.: US 2026/0200451 A1
(43) Pub. Date: Jul. 16, 2026

(54) ELECTROMECHANICAL BRAKING MECHANISM FOR A MOTOR VEHICLE

(71) Applicants: thyssenkrupp Presta AG, Eschen (LI); thyssenkrupp AG, Essen (DE)

(72) Inventors: Barna SZIMANDL, Gams (CH); Dennis PONGRATZ, Koblach (AT); Jan SLATINSKY, Buchs (CH)

(73) Assignees: thyssenkrupp Presta AG, Eschen (LI); thyssenkrupp AG, Essen (DE)

(21) Appl. No.: 19/136,594

(22) PCT Filed: Oct. 24, 2023
(86) PCT No.: PCT/EP2023/079654

§ 371 Date: Jun. 6, 2025

(30) Foreign Application Priority Data
Dec. 8, 2022 (BE) BE 2022/5999
Mar. 10, 2023 (BE) BE 2023/5178

(51) Int. Cl. B60T 13/74; F16D 55/225; F16D 65/18; F16D 65/38; F16D 65/56; F16D 121/24; F16D 125/36; F16D 125/40; F16D 125/48

(52) U.S. Cl. CPC B60T 13/746; F16D 55/225; F16D 65/18; F16D 65/567; B60T 2270/402; F16D 2065/386; F16D 2121/24; F16D 2125/36; F16D 2125/40; F16D 2125/48

(57) ABSTRACT

An electromechanical brake apparatus for a motor vehicle comprises an adjustment apparatus and a brake component which is connected thereto and which can be adjusted by the adjustment apparatus along an axis and brought into braking engagement with a counter-brake component, wherein the adjustment apparatus has a first actuator and a second actuator which is coupled thereto in series, wherein the first actuator has a rotatably drivable first drive wheel by which a first output element and a first drive element which can be adjusted axially relative thereto can be rotatably driven relative to each other, and the second actuator has a rotatably drivable second drive wheel which is coaxial relative to the first drive wheel and by which a threaded spindle which has a spindle thread which engages in an inner thread of the first actuator can be rotatably driven. In order to enable a more compact and less complex construction, the threaded spindle and the second drive wheel have corresponding, mutually engaging positive-locking elements which are configured to produce a positive-locking connection which is effective with respect to rotation about the axis in a circumferential direction and which can be axially displaced relative to each other.

### PRIOR ART

The invention relates to an electromechanical braking device for a motor vehicle, comprising an actuating device and a brake part which is connected thereto and by the actuating device is adjustable along an axis and is able to be brought into braking engagement with a mating brake part, wherein the actuating device has a first actuator and a second actuator which is coupled in series to the latter; wherein the first actuator has a first rotationally drivable drive wheel, and the second actuator has a second rotationally drivable drive wheel which is coaxial with the first drive wheel; wherein disposed between the first drive wheel and the second drive wheel is a friction clutch which comprises two friction elements having coaxial friction surfaces which for generating a clutch engagement are able to be connected to one another in a friction-fitting manner.

A braking device of this type of a motor vehicle is configured as a friction brake in which a brake part which is stationary relative to the rotation of the wheel to be braked and is supported on the chassis can, by means of an actuating device, be brought into braking engagement with a mating brake part rotating conjointly with the wheel. In the braking engagement, a frictional contact between the brake part and the mating brake part is generated, whereby the braking momentum generated by friction is all the greater the higher the adjustment force exerted in the adjustment direction by the actuating device.

A widely used construction mode are disk brakes, which are known in principle and in which the mating brake part is formed by a brake disk which rotates conjointly with the wheel and is axially encompassed on both sides by a brake caliper. A brake part, typically a brake pad, can be adjusted in an axial adjustment direction by at least one, preferably linear, actuator which is axially supported on the brake caliper, and as a result be brought into frictional contact with an axial side of the brake disk, whereby the brake disk is clamped in braking engagement in a friction-fitting manner between the adjusted brake part and a further brake part which is supported axially opposite on the brake caliper.

It is a precondition for flawless functioning and a precise response of the brake that in the non-activated state a defined spacing in the adjustment direction, the so-called air gap, is provided between the brake part and the mating brake part. When the brake is activated, the brake part is moved perpendicularly to the air gap toward the mating brake part by the actuating device, until the air gap is overcome and the frictional contact is achieved in such a way that the braking engagement is generated.

It is essential for a reproducible and precise response of the brake in the driving operation that the air gap in the non-activated state has a defined gap width measured in the axial adjustment direction. In the course of operation, the gap width can increase, for example as a result of wear of the brake pad, and has to be correspondingly adjusted. For adjusting the air gap, it is known from DE 10 2017 123 266 A1 that the actuating device has two actuators which are disposed in series in the adjustment direction. Each of the actuators has a drive-proximal drive element and an output-proximal output element which is linearly adjustable relative to the latter in the axial adjustment direction. In order to implement an adjustment movement, each drive element has a drive wheel, preferably a gear wheel such as a gearwheel or the like, which is driven so as to rotate about its axis by an electric servomotor. The rotation of the drive wheel is in each case converted in the actuator into a relative adjustment movement, or an actuating stroke, of the output element in the axial adjustment direction relative to the drive element. In the generic prior art, the two drive wheels of the first and of the second actuator are disposed coaxially on a common axis lying in the axial adjustment direction.

An actuator forms in each case a lifting or adjusting apparatus which is axially effective in the adjustment direction. For example, an actuator can have a spindle drive in which the drive element has a spindle nut, and the output element can have a threaded spindle which engages in the spindle nut, or vice versa. Other construction modes of actuators can also be used, which can comprise, for example, ramp bearings, plate cams or cam disks, tilting pin assemblies or the like, and likewise convert a rotation of the drive element into a linear adjustment of the output element.

Owing to the fact that the drive element of the second actuator is coupled to the output element of the first actuator, and the braking element is attached to the output element of the second actuator, by activating the first actuator the braking element can be linearly adjusted conjointly with the second actuator in order to generate the braking engagement. The air gap can be adjusted by adjusting the second actuator independently of the activation of the first actuator. In this way, the first actuator can be continuously operated in the optimal operating range.

A further advantage of the two coupled actuators lies in that a redundant design is possible. Thus, the braking engagement can fundamentally also be generated by the second actuator which in the normal operation is used only for adjusting the air gap.

In order to enable a synchronous rotation of the first and of the second drive element in the normal operation, so that the second actuator is entrained as an entity and is not adjusted in the process, it is proposed in DE 10 2017 123 266 A1 mentioned to provide a latching coupling between the first and the second drive wheel. As a result, the two drive wheels can be coupled in separate, releasable latching steps which are able to latch into one another in a form-fitting manner, so that a reliable transmission of torque for synchronization is enabled. However, the predefined discrete latching steps must also be overcome in order to set the air gap. It is disadvantageous herein that only a step-by-step adjustment of the air gap is possible, as a result of which it is not possible to satisfactorily compensate for the continuous wear on the braking element. Moreover, a relatively high drive torque is required to overcome the latching steps.

In order to overcome the aforementioned disadvantages of the known coupling, it is proposed in application BE 2022/5999, which has not been published, to implement a friction clutch which acts continuously in terms of the clutch engagement. This friction clutch has friction elements which are attached to both drive wheels and have coaxial, mutually opposite friction surfaces which for generating a clutch engagement can be brought into frictional contact. The friction elements are formed separately and co-rotationally coupled to the drive wheels. As a result, the complexity in terms of manufacturing and assembling, and the required installation space and the weight, are relatively high.

In view of the set of issues discussed above, it is an object of the present invention to enable a reduced complexity in terms of manufacturing and assembly in association with a smaller installation space requirement and a lower weight.

### SUMMARY OF THE INVENTION

This object is achieved according to the inventio by the braking device having the features of claim 1. Advantageous refinements are derived from the dependent claims.

It is provided in an electromechanical braking device for a motor vehicle, comprising an actuating device and a brake part which is connected thereto and by the actuating device is adjustable along an axis and is able to be brought into braking engagement with the mating brake part; wherein the actuating device has a first actuator and a second actuator which is coupled in series to the latter; wherein the first actuator has a first rotationally drivable drive wheel, and the second actuator has a second rotationally drivable drive wheel which is coaxial with the first drive wheel; wherein disposed between the first drive wheel and the second drive wheel is a friction clutch which comprises two friction elements having coaxial friction surfaces which for generating a clutch engagement are able to be connected to one another in a friction-fitting manner, that according to the invention at least one friction element is formed integrally with the first drive wheel or the second drive wheel.

Hereunder, the first and the second drive wheel are conjointly also referred to as the two drive wheels, or as the drive wheels for short. The one drive wheel herein has one friction element, and the other drive wheel has one corresponding friction element which interacts with the latter and which can also be referred to as the mating friction element. Accordingly, the friction element and the mating friction element hereunder are also conjointly referred to as the friction elements. The friction element herein, in accordance with the definition, is the part of the friction clutch that has the friction surface.

The drive wheels can in each case be designed as a gearwheel, for example as a spur gear, or as a belt pulley or timing belt pulley, or as a worm gear, so that in general terms a gear wheel is provided by way of which a drive torque from an electric servomotor can be coupled into the actuator.

According to the invention, the friction element in terms of construction is designed to be integrated with the drive wheel. Preferably both drive wheels can be designed accordingly. The integrated design embodiment advantageously enables more economical manufacturing, and the reduced number of components enables simplified assembling. Moreover, a more compact construction mode with a smaller installation space requirement and reduced weight can be implemented.

An advantageous refinement can provide that the friction element is formed integrally with the drive wheel. As a result, the functioning elements for coupling in the drive torque, for example a gear rim or the like, can be implemented conjointly with the friction element on a continuously integrated component, this being advantageous in particular with a view to a compact construction mode and a low weight. Owing to the fact that no joining connections are required, manufacturing can moreover be simplified, and the load bearing capability can be increased.

It can be provided that the drive wheel has a casting. The casting can be an injection-molded part made of a thermoplastic plastics material, which can optionally be fiber-reinforced for increasing strength, or be a die-casting from a metallic material, for example from aluminum, magnesium or zinc alloys. The friction element herein can be integrally molded to the drive wheel in the casting method. As a result, economical manufacturing and a weight-saving and assembly-friendly embodiment is enabled.

It is likewise possible that the drive wheel is formed from castings which are connected to one another, for example made by bi-component injection-molding, in which the friction element can be composed of another material than other functional elements of the drive wheel, for example a hub or a revolving gear rim. It is also conceivable and possible that different functional elements of the drive wheel are connected to one another in a materially integral manner so as to form an integral component in an injection method. For example, a friction element can be over molded with a gear rim from a plastics material, or a hub part from plastics material can be injected into a gear rim, said hub part being connected to the friction element.

Alternatively, it can be provided that the drive wheel is generated integrally or in one piece by subtractive machining, for example from steel. Combined machining methods may also be used; for example, a casting or a stamped part can subsequently be subtractively machined.

It can be provided that the drive wheel has a sintered part. Complex and complicated geometries and shapes can be produced economically in high volumes by means of sintering.

It can be provided that the drive wheel has a gearwheel, for example a spur gear. The latter can have a gear rim which coaxially encircles a hub part on the outside. According to the invention, the friction element, conjointly with the gear rim, can be formed integrally or in one piece with the hub part. Manufacturing can take place by a casting method, for example as an injection-molded plastic part, or as a metal casting, and additionally or alternatively by subtractive machining.

In order to optimize the surface properties required for the respective function, the drive wheel, which according to the invention is integral or in one piece, can have at least in portions a surface coating and/or a surface structure. For example, a surface coating, for example in the form of a friction-reducing plastics material coating, can be applied in the region of a toothing of a gearwheel, so as to optimize the rolling and wear behavior and to reduce the emission of noise. An optimal friction pairing with a defined adhesive and frictional behavior can, in the region of the friction surfaces, be generated by a targeted modification of one or both friction surfaces, for example by specifying a defined roughness, and/or a coating with adapted coefficients of friction at reduced wear, for instance by a hard-material coating or surface modification by partial thermal treatment or the like.

It can preferably be provided that the friction elements are of a conical design. The one friction element has a conical external face at least in portions, which forms a friction surface converging conically in the axial adjustment direction. The other friction element, thus the corresponding mating friction element, has a conical opening having a conical internal face which is adapted to the external face and forms the other friction surface. The friction surfaces have identical cone angles and are mutually adapted in terms of the diameter and the axial length in such a way that they can brought into frictional surface contact by an activation force of the clutch exerted in the axial adjustment direction. The conical design of the friction surfaces has the advantage that, by specifying the cone angle, a defined transmission ratio of force between the activation or preload force of the clutch exerted axially on the friction elements and the resultant normal force acting between the conical friction surfaces can be generated, this determining the frictional force in the circumferential direction that is relevant to the transmission of the coupling torque. A high transmission of force by way of a relatively small cone angle can be generated in the process, in which a relatively high frictional compression between the conical friction surfaces and a correspondingly high coupling torque can be implemented by way of a relatively small activation or preload force.

The cone angle is preferably sized in such a manner that no self-locking takes place between the friction surfaces. In this way, a reliable disengagement of the clutch can be ensured. Half the cone angle α/2 is larger than the arc tangent of the coefficient of static friction μ acting between the friction surfaces. Thus: α/2>arctan (μ). Half the cone angle α/2 is particularly preferably more than 7°, most particularly preferably 10°.

In the aforementioned embodiment it can be provided that the friction elements are of a frustoconical design. The one friction element herein has a truncated cone which projects axially in a convex manner in the adjustment direction and has an annularly encircling conical external face which forms the one friction surface. The other friction element has a cone opening, which is axially delimited and adapted to the truncated cone in a form-fitting manner and has an annular conical internal face which forms the other friction surface. In order to engage the friction coupling, the truncated cone is introduced axially into the cone opening until the conical friction surfaces come into frictional contact, i.e. lie against one another in a friction-fitting manner. The friction surfaces can have the shape of coaxially encircling conical rings which according to the invention are formed integrally or in one piece with the drive wheel. As a result, a spindle drive of one of the actuators can be passed through the drive wheels so as to be coaxial with the friction surfaces, as a result of which a particularly compact construction mode is enabled.

It is advantageous that the friction elements have end faces which are axially spaced apart from one another. The truncated cone has on the front of its conically converging end an end face which has an axial face. The cone opening has on its inner end likewise an axial end face which axially delimits the internal face and which in other words forms an axial base area of the cone opening which lies axially opposite the frontal axial face of the truncated cone. The conical friction surfaces herein are designed and sized in such a way that the axial faces in the friction-fitting clutch engagement have a mutual axial spacing.

Alternatively or additionally to the aforementioned embodiment it can be provided that the friction surfaces are of a planar design. The friction element and the corresponding mating friction element herein have flat friction surfaces which can at least in portions be formed as planar axial faces, similar to a disk clutch.

In the invention, a friction clutch is implemented between the drive wheels. Said friction clutch comprises a friction element which is connected in a torque-fitting manner to one of the drive wheels, and comprises a corresponding mating friction element which is connected in a torque-fitting manner to the respective other drive wheel. The friction element can be brought into a friction-fitting clutch engagement with the mating friction element in any arbitrary relative angular position. In the process, a force-fitting coupling is implemented, as opposed to the form-fitting latching connection in the prior art mentioned at the outset. As a result, the mutual relative position of the drive wheels can be continuously specified. Accordingly, a uniform, continuous adjustment of the second actuator relative to the first actuator is enabled, and a continuous adjustment of the air gap can take place. This is particular advantageous with a view to a uniform tracking of the optimal operating point of the braking device so as to follow continuous wear on the brake part during operation, i.e. the continuous wear on the brake pad. Owing to this fact, an improved responsive behavior of the braking device, and thus an increased operational reliability and a high level of operating comfort, can be implemented.

A further advantage in comparison to the latching coupling mentioned at the outset lies in that no axial relative movement between the clutch elements in clutch engagement is substantially required for activating and releasing the clutch device, for example between the drive wheels or the latching elements which for generating and releasing the latching-capable form-fit inevitably have to be movable relative to one another. In contrast, the pure force flux between the friction elements and mating friction elements according to the invention can be simply predefined by the applied axial activation force, wherein the friction element and the mating friction element do not have to be moved axially relative to one another. As a result, a simpler and more reliable structural design of the clutch device is enabled.

It is possible that the friction clutch has a clutch toque which is able to be specified in a defined manner. The coupling torque indicates the maximum differential torque which can be transmitted in a force-fitting manner between the friction elements as a result of the friction-fit in the clutch engagement. The clutch device slips when exceeding the coupling torque, so that the two drive wheels are twisted relative to one another. It is an advantage herein that the friction clutch according to the invention continuously slips in a sliding manner, so that an improved uniform readjustment of the air gap is enabled. Moreover, no axial compensating movements of the latching elements, as in the known latching coupling, have to be taken into account and absorbed in the construction.

It is advantageous that the friction elements are disposed coaxially. The coaxial arrangement herein corresponds to the coaxial arrangement of the drive wheels. The friction elements can be disposed in the region of the end sides of the drive wheels that are directed axially toward one another, which is simple in terms of construction and offers a compact construction mode.

It can preferably be provided that the friction elements are preloaded in relation to one another. The friction elements in the clutch engagement are preferably elastically or resiliently preloaded in relation to one another. In the process, the friction surfaces in the friction-fit are pressed against one another with a specified axial preload force. The preload force is referred to synonymously as the activation force of the clutch. An elastic preloading element, for example a spring element or the like, can preferably be provided for generating the preload force. The coupling torque of the friction clutch is determined by the activation force acting perpendicularly to the frictional contact, thus the force which is applied axially between the friction elements, wherein the coupling torque is all the greater, the higher the preload force (activation force).

This opens up the advantageous possibility of specifying the coupling torque simply by the preload force exerted by the preloading element. For example, in the case of a spring element which is compressively elastic in the axial direction, such as a compression spring, the exerted preload force can be simply specified and adapted by way of the spring rate and the compression of the spring.

It is possible that one or both friction elements is/are disposed in the first drive wheel or the second drive wheel. In this way, it is possible, for example, to design the one drive wheel so as to be substantially drum-shaped, so that the friction element or mating friction element can be disposed in an interior space which is enclosed by the revolving gearwheel or gear rim. A compact construction mode which is protected against external influences is enabled as a result. In this way, the drive wheel of the first actuator can have a conical friction element, which engages axially in a mating friction element that is formed as an internal cone and is at least partially disposed within the second drive wheel, for example.

In particular in the embodiment last mentioned, a particularly compact construction mode can be implemented in that the drive wheels are disposed within the axial extent of the actuators, thus are not attached so as to project axially on one side.

It is preferable that one or both friction elements have a friction pad. The friction elements can, for example, have a metallic base body, for example from steel or a metal casting. For the avoidance of metal-on-metal contact, a coating or a pad for generating a friction pairing having a defined friction force, for example made of sintered, metallic and/or ceramic friction materials, composite materials, or the like, can preferably be applied. A defined reproducible coupling torque can be guaranteed as a result.

It can be provided that an actuator has a spindle drive. In the latter, a threaded spindle engages in a spindle nut in a manner known, and a relative rotating drive engages by way of a drive wheel connected to the threaded spindle or the spindle nut. It is possible that the spindle nut forms the drive-proximal drive element of the actuator, and the threaded spindle forms the output-proximal output element which is linearly adjustable relative to said drive element, or vice versa.

According to the invention, it is preferably possible that the spindle thread is formed integrally, or particularly preferably in one piece, with a drive wheel. In this way, in addition to the function of the friction element, the function of the spindle nut of a spindle drive can be designed to be integrated with the drive wheel. As a result, a reduced complexity in terms of manufacturing and assembly, and a further saving in terms of installation space and weight, is enabled.

It is possible that an actuator has a ball ramp assembly, a V-pulley assembly, or a tilting pin assembly. In a ball ramp assembly, also referred to as a ramp bearing, the drive element and the output element preferably have cam disks with races or ramps inclined toward the axis, balls rolling in the circumferential direction being disposed therebetween. As a result of the balls rolling on the ramps, a relative rotation leads to the output element being displaced axially relative to the drive element. In a tilting pin assembly, which is known per se, tilting pins are disposed between the drive element and the output element and are in each case supported in the circumferential direction in such a way that during a relative rotation said tilting pins are inclined more or less toward the axis, depending on the direction of movement, as a result of which the spacing between the drive element and the output element is likewise adjustable.

It is possible that the drive wheel has at least one functional element of an actuator. In this way, it is possible to combine in terms of construction the functional elements of one or both actuators in one drive wheel integrated according to the invention. For example, a drive wheel can have integrally, or in one piece, an internal thread of a spindle nut, races of a ball ramp assembly, V-elements of a V-pulley assembly, supporting elements of a tilting pin assembly, or the like, and additionally or alternatively a spindle thread of a spindle nut or the like. As a result, a plurality of functions can advantageously be implemented in an integral, or preferably one-piece, drive wheel according to the invention. As a result, a further saving in terms of installation space and weight can be implemented in association with reduced complexity in manufacturing.

Two identically functioning actuators, for example two spindle drives, can be combined as first and second actuators in the actuating device. It is also possible to combine two different construction modes with one another, for example a ball ramp assembly as a first actuator, and a spindle drive as a second actuator for adjusting the air gap. Here, the respective characteristic properties of each construction mode can be optimally utilized. For example, a non-linear adjustment characteristic, and/or self-locking properties at least in portions, and/or a defined dead center position or extended position enabling a defined adjustment travel, can be implemented with little complexity by way of a ball ramp assembly. The implementation of the mentioned positive properties can at least to some extent require a precise specification of the air gap, which is not possible using the latching coupling in the prior art, but can be readily implemented by means of the friction clutch according to the invention.

In a method for operating an electromechanical braking device, which has an actuating device comprising a first actuator and an actuator coupled in series to the latter, and which acts on a brake part which in the direction of an axis is able to be brought into braking engagement with a mating brake part, wherein the first actuator has a rotationally drivable first drive wheel to which a first drive torque can be applied for activation, and the second actuator has a rotationally drivable second drive wheel, which is coaxial with the first drive wheel and to which a second drive torque can be applied for activation, wherein a clutch device is disposed between the first drive wheel and the second drive wheel, it can be provided that the clutch device is designed as a friction clutch and has a specifiable coupling torque, the first drive wheel slipping in a sliding manner relative to the second drive wheel when said coupling torque is exceeded, wherein for activating the first actuator, the first drive wheel and the second drive wheel are driven synchronously in such a way that the second actuator remains non-activated, and for activating the second actuator, the second drive wheel is driven and the first drive wheel is stopped relative to the latter in such a way that the friction clutch slips and the first actuator remains non-activated.

The features mentioned above in the context of the braking device according to the invention can be utilized individually and in combination in order to implement the method.

For adjusting the first actuator, an actuating torque can be coupled into the first drive wheel by means of a first electric servomotor, and the second actuator can correspondingly be driven by a second electric servomotor.

In the normal braking operation, the first and the second drive wheel are rotated synchronously. This can take place, on the one hand, in that the first and the second drive wheel are driven by the first and the second servomotors with synchronized drive torques. On the other hand, when driving the first drive wheel, the second drive wheel can be synchronously entrained by the clutch device as long as the transmitted drive torque remains below the coupling torque. In this operating mode, the second actuator remains non-activated and as an inactive entity is rotated conjointly with the braking element.

During operation, the clutch device for adjusting the air gap can slip continuously and uniformly in a sliding manner when exceeding the coupling torque. This can be implemented, for example, in that the drive wheel of the first actuator is stopped, for example by a brake or by a corresponding actuation of the first drive motor, while a second drive torque, greater than the coupling torque, is applied to the second drive wheel by the second drive motor. As a result, the second drive wheel is twisted relative to the first drive wheel, and the air gap can be continuously and finely adjusted by activating the second actuator in such a way that continuously progressing wear on the braking element, or on the brake pad, can be optimally compensated.

It is possible that the first drive wheel and the second drive wheel are coupled in a torque-fitting manner so as to generate a synchronous drive via the friction coupling. Here, no synchronous drive of the two drive wheels by the servomotors is required. Potential differential torques can be balanced within specified tolerances.

It can be advantageously provided that a higher coupling torque is specified when activating the first actuator than when activating the second actuator. The first actuator is activated by a synchronous drive of the first and the second drive wheel. The friction element and the mating friction element are preloaded in relation to one another by the spring force of the spring element, and the adjustment force of the first actuator acts additionally counter to spring force. As a result, a relatively high coupling torque is implemented. However, if only the second drive wheel is rotated for adjusting the air gap, it is only the spring force that acts, so that a lower coupling torque is set. The adjustment of the air gap is facilitated as a result.

### DESCRIPTION OF THE DRAWINGS

Advantageous embodiments of the invention will be explained in more detail hereunder by means of the drawings in which:

FIG. 1 shows a braking device according to the invention in a schematic perspective view;

FIG. 2 shows a lateral view of the braking device according to FIG. 1;

FIG. 3 shows the actuating device according to the invention of the braking device according to FIG. 1 individually in a schematic perspective view;

FIG. 4 shows a section Q-Q through the braking device according to FIG. 1;

FIG. 5 shows the first actuator of the braking device according to FIG. 1 individually in a schematic perspective illustration;

FIG. 6 shows an actuating device according to the invention and according to FIG. 4 in a schematic sectional perspective view; and

FIG. 7 shows an enlarged detail view from FIG. 6.

### EMBODIMENTS OF THE INVENTION

In the various figures, identical parts are always provided with the same reference signs and are each therefore typically also only referred to or mentioned once.

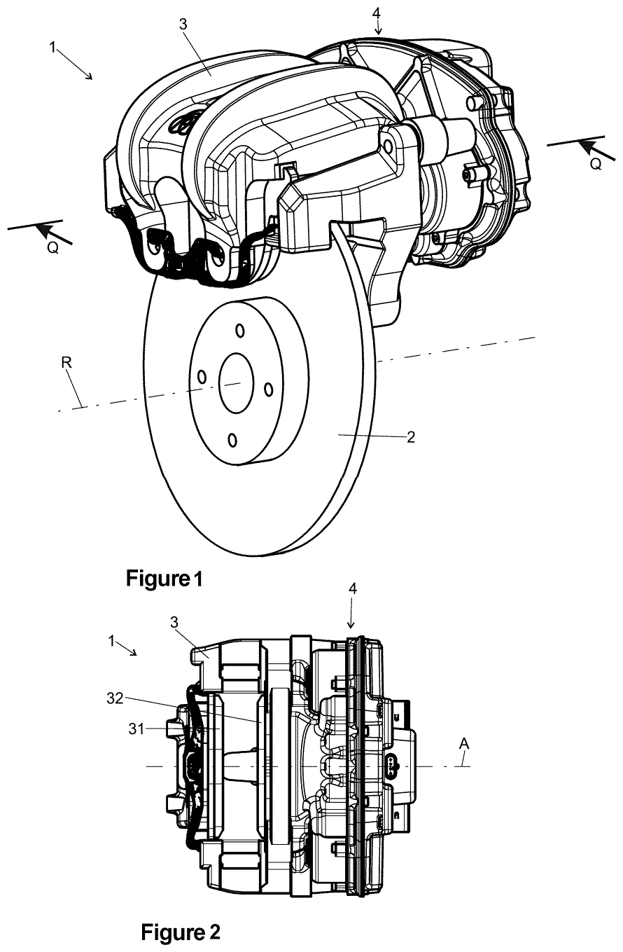

FIG. 1 shows a braking device according to the invention as an entity, which is designed as a disk brake. The latter comprises a brake disk 2 which forms a mating brake part in the context of the invention, and is connected to a vehicle wheel which is not illustrated here and is rotatable about a wheel axis R. A brake caliper 3 encompasses the two axial end faces of the brake disk 2.

The brake disk 2 here is designed as a non-ventilated brake disk made from a solid material. Alternatively, said brake disk 2 can also be designed as an internally ventilated brake disk.

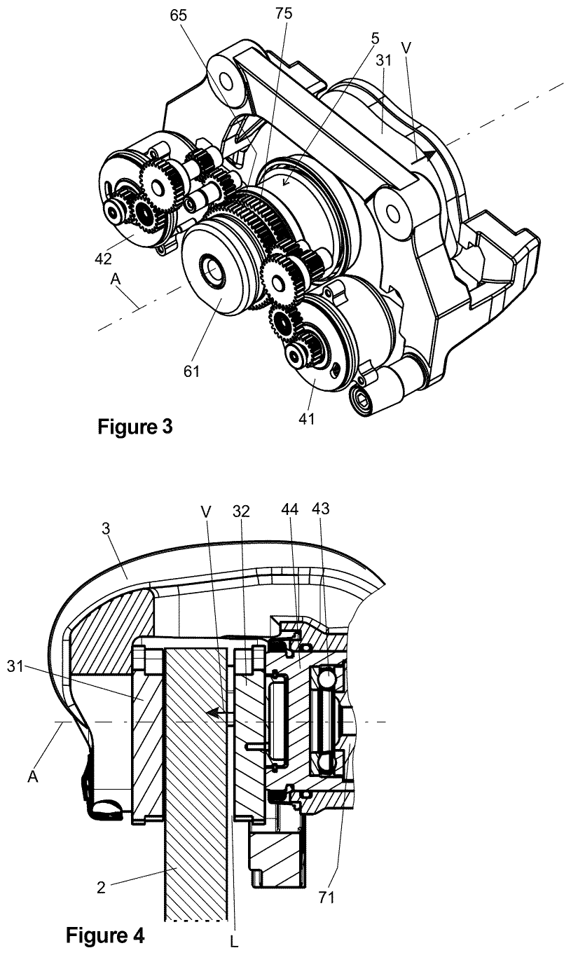

An electric brake actuator 4 according to the invention, which is shown individually in a separate schematic perspective view in FIG. 3 and is explained in detail in FIGS. 4 to 7, is attached to the brake caliper 3.

The brake actuator 4 comprises an actuating device 5 which extends axially in the direction of an axis A which lies parallel to the wheel axis R and indicates the adjustment direction V of the actuating device 5.

As can be seen in the sectional illustration of FIG. 4 along the axis A, the brake disk 2 is disposed axially between two brake pads 31 and 32. The one brake pad 31 is fixedly supported on the brake caliper 3 on the side that faces away from the brake actuator 4. The other brake pad 32, which in the context of the invention forms a brake part, is attached to the actuating device 5 and, for generating the braking engagement, is adjustable by the latter toward the brake disk 2 in the axial adjustment direction V defined by the axis A, as is indicated by the arrow in FIG. 4.

In the non-activated state of the braking device 1, an axial air gap L, which in FIG. 4 is schematically plotted as being of an exaggerated width, is located between the brake disk 2 and the adjustable brake pad 32.

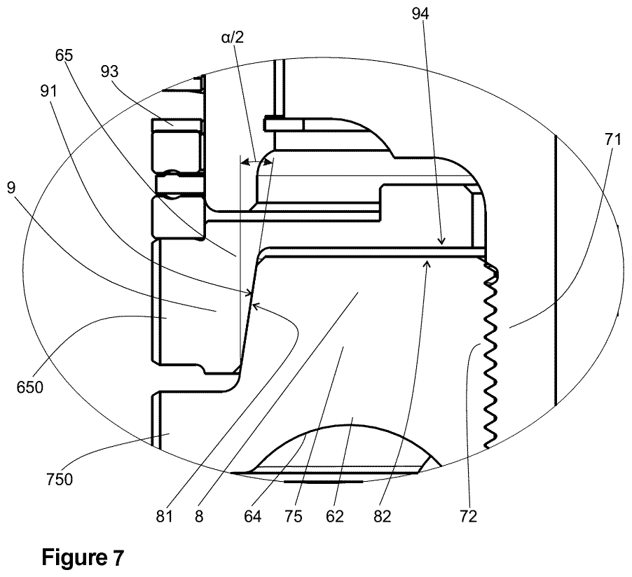

The construction of the actuating device 5 is illustrated in FIG. 4, and is schematically illustrated in a partially sectional perspective view along the axis A in FIG. 6. FIG. 7 shows an enlarged fragment from FIG. 6.

The actuating device 5 comprises a first actuator 6 which has a ramp bearing, and a second actuator 7 which is axially coupled in series thereto (in terms of the axis A) and has a spindle drive.

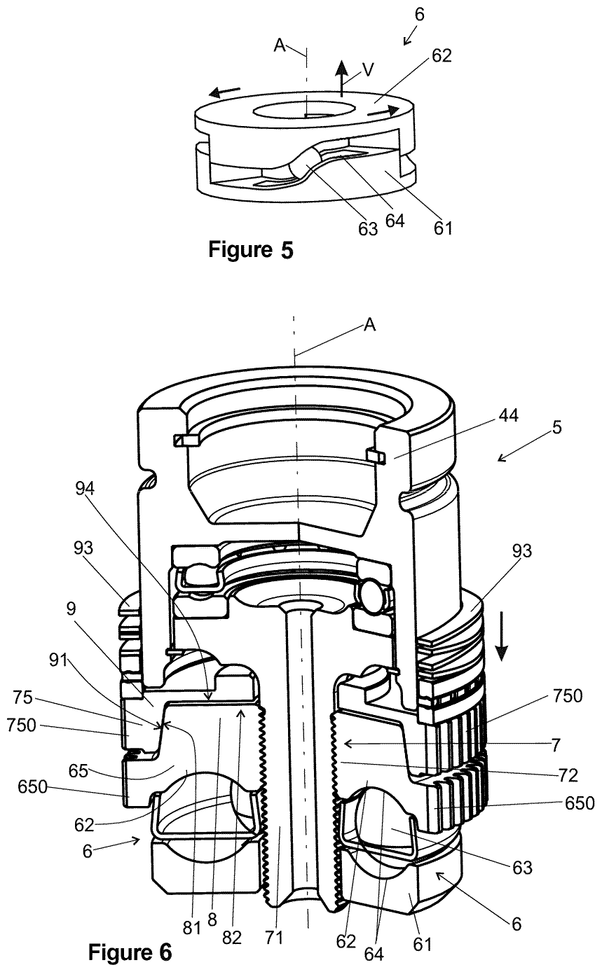

The first actuator 6, which in the example shown is designed as a ramp bearing, comprises a drive-proximal cam disk 61, which is supported axially and co-rotationally on the brake actuator 4, and an output-proximal cam disk 62. Balls 63 are disposed between the cam disks 61 and 62. As can be seen in the schematic individual view of FIG. 5, the cam disks 61 and 62 have ramp-type races 64 which lie axially opposite one another and obliquely in relation to the axis A and between which balls 63 are able to roll. A rotation of the output-proximal cam disk 62, at the top in FIG. 5, relative to the stationary drive-proximal cam disk 61—as is schematically indicated by the curved arrows—leads to a linear adjustment of the output-proximal cam disk 62 in the adjustment direction V parallel to the axis A. As a result, the brake pad 32 can be brought into braking engagement by activating the first actuator 6, as is plotted in FIG. 4.

The cam disk 62 is connected to a coaxial gearwheel 65 which is designed as a spur gear having a gear rim 650 revolving coaxially on the outside and forming a drive wheel in the context of the invention. In the example shown, the cam disk 62 is formed integrally with the gearwheel 65. The latter is designed according to the invention, as will yet be explained further below.

The gearwheel 65 by way of the gear rim 650 is in transmission engagement with a first electric servomotor 41. The latter enables the rotating drive of the cam disk 62, and thus an activation of the first actuator 6.

The second actuator 7, which in the example shown is formed as a spindle drive, has on the output side a threaded spindle 71 which engages in the internal thread of a drive-proximal spindle nut 72. This internal thread is formed in the output-proximal cam disk 62 of the first actuator 6, which is formed integrally with the gearwheel 65, so that the functions of the output-proximal cam disk 62 and of the drive-proximal spindle nut 72 are in terms of construction combined in the gearwheel 65.

The gearwheel 65 is rotatably mounted so as to be axially supported (fixed) in the brake actuator 4.

The gearwheel 75 can be embodied as a spur gear, in manner analogous to the gearwheel 65, having an encircling gear rim 750, and is disposed so as to be coaxially adjacent thereto. The gearwheel 75 is in transmission engagement with a second electric servomotor 42. The latter enables the rotating drive of the threaded spindle 71, and thus an activation of the second actuator 7.

The threaded spindle 71, by way of a thrust bearing 43, for example an axial roller bearing as illustrated, is connected axially to a thrust piece 44 to which the displaceable brake pad 32 is attached, as can be seen in FIG. 4. The thrust piece 44 can also be referred to as a piston.

The clutch device according to the invention has a friction element 8 which as a coaxial conical appendage is directed from the cam disk 62 toward the second actuator 7. The conical appendage has a conical friction surface 81 which is disposed externally on an external cone. According to the invention, the friction element 8 is formed integrally, in the example shown in one piece, with the gearwheel 65. As mentioned above, the cam disk 62 and the spindle nut 72 can likewise be formed in one piece with the latter.

In the clutch engagement, the friction element 8 is coupled in a friction-fitting manner to a mating friction element 9. In the process, the conical appendage plunges axially into a corresponding conical opening, i.e. a cone opening of the mating friction element 9, said cone opening having a conical friction surface 91 disposed in an internal cone. In the clutch engagement, the friction surface 81 and the mating friction surface 91 lie against one another in a friction-fitting manner, as can be clearly seen in FIG. 6.

According to the invention, the friction element 9 is formed integrally, in the example shown in one piece, with the gearwheel 75.

A spring element 93 is disposed between the gearwheel 75 and a stationary part of the brake caliper 3. As a result of the axially effective spring force of said spring element 93, the mating friction element 9 is elastically braced in relation to the friction element 8, as is indicated by the downward-directed arrow in FIG. 6. In other words, the spring element 93 generates an activation force of the friction clutch. This activation force is converted into an increased normal force by way of the flat converging cone angle, said normal force being the force by which the friction surfaces 81 and 91 are loaded in relation to one another in the clutch engagement. As a result, a defined coupling torque of the friction clutch according to the invention, which is formed by the friction element 8 and the mating friction element 9, is generated.

The friction element 8 is of a frustoconical design and has a flat axial end face 82 which delimits the truncated cone in the adjustment direction and lies at the top in FIG. 6. The cone opening of the mating friction element 9 likewise has a flat axial end face 94 which forms the base of the cone opening, the latter lying at the top in FIG. 6. The end faces 82 and 94 which lie axially opposite one another have a mutual axial spacing in the clutch engagement, i.e. when the friction surfaces 81 and 91 lie against one another in a force-fitting manner.

For activating the braking device 1, the gear wheels 65 and 75 are rotated synchronously so that the first actuator 6 carries out a working stroke in the adjustment direction V in such a way that the brake pad 32 passes the air gap L and comes into braking engagement with the brake disk 2. The synchronous drive of the gear wheels 65 and 75 can be established by synchronizing the drive speeds of the servomotors 41 and 42, or by driving by only one of the servomotors 41 or 42 while the respective other servomotor 42 or 41 rotates conjointly while being inactive. In this instance, the friction-fitting clutch engagement between the friction element 8 and the mating friction element 9 ensures a synchronous rotation of the gear wheels 65 and 75.

For adjusting the width of the air gap L, the gearwheel 65 is stopped or blocked, for example by correspondingly activating the first servomotor 41. The gearwheel 75 is twisted relative to the gearwheel 65 by the second servomotor 42, whereby the friction clutch continuously slips in a sliding manner. Accordingly, the second actuator 7 is adjusted uniformly, as a result of which the width of the air gap L can likewise be continuously set and adapted, for example in order to compensate wear on the brake pad 32.

Owing to the fact that the friction element 8 and the mating friction element 9 are disposed completely, or at least partially, within the gear wheels 65 and 75, a particularly compact construction mode can be implemented.

The braking devices illustrated in FIGS. 1 to 7 are designed as a floating caliper brake, also referred to as a sliding caliper brake. Here, the brake pad 32 is pressed against the brake disk 2 by the thrust piece 44, and the brake pad 31 is pressed against the brake disk 2 by the brake caliper 3 which is displaceable relative to the brake disk 2 in the direction of the axis A.

Alternatively, the solution according to the invention can also be used in a fixed caliper brake.

### LIST OF REFERENCE SIGNS

1 Braking device
2 Brake disk
3 Brake caliper
31, 32 Brake pad
4 Brake actuator
41, 42 Servomotor
43 Thrust bearing
44 Thrust piece
5 Actuating device
6 First actuator
61 Cam disk
62 Cam disk (integrated with spindle nut 72)
63 Bal
64 Race
65 Gearwheel
650 Gear rim
7 Second actuator
71 Threaded spindle
72 Spindle nut (integrated with cam disk 62)
74 Hub part
75 Gearwheel
750 Gear rim
8 Friction element
81 Friction surface
82 End face
9 Mating friction element
91 Mating friction surface
92 Dog
93 Spring element
94 End face
A Axis
R Wheel axis
V Adjustment direction
L Air gap

1-14. (canceled)

15. An electromechanical braking device for a motor vehicle, comprising:
an actuating device; and
a brake part that is connected to the actuating device and by the actuating device is adjustable along an axis and is able to be brought into braking engagement with a mating brake part;
wherein the actuating device has a first actuator and a second actuator which is coupled in series to the first actuator;
wherein the first actuator has a first rotationally drivable drive wheel, and the second actuator has a second rotationally drivable drive wheel which is coaxial with the first drive wheel;
wherein disposed between the first drive wheel and the second drive wheel is a friction clutch which comprises two friction elements having coaxial friction surfaces which for generating a clutch engagement are able to be connected to one another in a friction-fitting manner;
wherein at least one friction element is formed integrally with the first drive wheel or the second drive wheel.

16. The braking device as claimed in claim 15, wherein the friction element is formed integrally with the drive wheel.

17. The braking device as claimed in claim 15, wherein the drive wheel has a casting or a sintered component.

18. The braking device as claimed in claim 15, wherein the drive wheel has a gearwheel.

19. The braking device as claimed in claim 15, wherein the drive wheel has at least in portions a surface coating and/or or a surface structure.

20. The braking device as claimed in claim 15, wherein the friction elements are of a conical design.

21. The braking device as claimed in claim 15, wherein the friction elements are of a frustoconical design.

22. The braking device as claimed in claim 15, wherein the friction elements have end faces which are axially spaced apart from one another.

23. The braking device as claimed in claim 15, wherein the drive wheel has at least one functional element of an actuator.

24. The braking device as claimed in claim 15, wherein the friction surfaces are of a planar design.

25. The braking device as claimed in claim 15, wherein the friction elements are preloaded in relation to one another.

26. The braking device as claimed in claim 15, wherein at least one friction element has a friction pad.

27. The braking device as claimed in claim 15, wherein an actuator has a spindle drive.

28. The braking device as claimed in claim 15, wherein an actuator has a V-pulley assembly, a ball ramp assembly, or a tilting pin assembly.
